(19) United States
(12) Patent Application Publication
(10) Pub. No.: US 2018/0164226 A1
(43) Pub. Date: Jun. 14, 2018

(54) METHOD FOR FURTHER PROCESSING A GLASS TUBE SEMI-FINISHED PRODUCT

(71) Applicant: SCHOTT AG, Mainz (DE)

(72) Inventors: André Witzmann, Waldershof (DE); Andreas Wirth, Buhler (CH); Ulla Trinks, Mitterteich (DE)

(73) Assignee: SCHOTT AG, Mainz (DE)

(21) Appl. No.: 15/835,689

(22) Filed: Dec. 8, 2017

(30) Foreign Application Priority Data
Dec. 8, 2016 (DE) 102016123865.1
Dec. 30, 2016 (DE) 102016125944.6
Feb. 3, 2017 (DE) 102017102161.2

(51) Int. Cl. G01N 21/896; B41M 5/26; C03C 23/00

(52) U.S. Cl. CPC G01N 21/896; B41M 5/262; G06F 17/30286; C03C 23/007; C03C 23/0025

(57) ABSTRACT

A method for further processing a glass tube semi-finished product includes: providing the glass tube semi-finished product, along with defect data for the glass tube semi-finished product; reading the defect data for the glass tube semi-finished product; and further processing the glass tube semi-finished product, for example by cutting to length or sorting out. The further processing of the glass tube semi-finished product is adapted to the defect data, which were read out for the glass tube semi-finished product. In this way, the further processing can be more efficiently adapted to the respective characteristics of a glass tube semi-finished product to be processed or a specific sub-section thereof, and the relevant defects of the respective glass tube semi-finished product do not need to be determined or measured again.

### CROSS-REFERENCE TO RELATED APPLICATIONS

The present application claims priority to German patent application nos. DE 10 2016 123 865.1 filed on Dec. 8, 2016, DE 10 2016 125 944.6 filed on Dec. 30, 2016, and DE 10 2017 102 161.2 filed on Feb. 3, 2017, the entire contents of which are hereby incorporated by reference.

### FIELD OF THE INVENTION

The present invention relates in general to the further processing of glass tube semi-finished products into end products, e.g., into hollow glass products, and relates in particular to the further processing of glass tubes to closely toleranced end products, such as containers for storing pharmaceutical, medical or also cosmetic substances, for example vials, cartridges or syringe bodies. The further processing of the glass tube semi-finished products may also include a thermal forming of the glass tube semi-finished products performed at least in sections into end products or hollow glass products.

### BACKGROUND OF THE INVENTION

For the further processing of glass tubes, the process parameters of a further processing apparatus must be adjusted as well as possible to the characteristics of a respective glass tube in order to ensure optimum quality of the end products. This is difficult and expensive particularly in the production of closely toleranced end products.

To increase the quality of such end products, in a further processing company the relevant characteristics of glass tubes are determined according to the prior art by means of suitable measuring devices. Only then can the relevant process parameters be adjusted accordingly. This not only delays the further processing of glass tubes but also makes it laborious and expensive.

Various methods for marking and coding glass tube semi-finished products are known from the prior art. However, they are not used for coding characteristics of the glass tube semi-finished products in such a way that the relevant data are available directly to a further processing company and can be further used by it directly.

For marking or coding glass, methods are known from the prior art in which markings or the like are inscribed directly in the glass material. Such a method is disclosed, for example, in US 2003 0029849 A1, DE 102 34 002 A1 and WO 2012 028611 A1 of the applicant, the contents of which are expressly incorporated herewith by way of reference. In this case, the glass is acted upon in sections by a laser pulse to apply a marking on the surface. The marking is clearly visible and can be reliably read out, in particular by way of a lens effect exerted by the marking, it can be applied free of stress even during production at high temperatures and is therefore suitable for applying the marking even during the production of glass tube semi-finished products, i.e. during the actual tube shaping. A particular advantage of this method is that the marking can be applied at temperatures above the transformation temperature of the glass without the temperature of the glass tube strand having to be increased to such high temperatures again after the actual tube shaping. With the method, markings to combat product piracy but also trademarks, company logos or other product features can be applied to the glass tube strand.

Other methods for marking glass substrates are disclosed in WO 2004 000749 A1 and WO 2009 128893 A1.

DE 103 35 247 A1 discloses a method for pattern optimization of plate glass.

### BRIEF SUMMARY OF THE INVENTION

Accordingly, there exists a need for an enhanced method for the further processing of glass tube semi-finished products, with which it is possible to reliably produce end products made of glass in a simple and cost-effective manner, particularly hollow glass products, which in particular meet higher quality requirements, in particular are more closely toleranced.

According to a first aspect of the present invention, there is provided a method for further processing of a glass tube semi-finished product, comprising the steps of: providing the glass tube semi-finished product, wherein defect data are provided for the glass tube semi-finished product; reading out the defect data for the glass tube semi-finished product; and further processing the glass tube semi-finished product, wherein the further processing of the glass tube semi-finished product particularly may also include a thermal forming carried out at least in sections, e.g. to a hollow glass product or glass container, and wherein the further processing of the glass tube semi-finished product is adapted to the defect data read out for the glass tube semi-finished product.

For example, if the defect data of a glass tube semi-finished product to be processed indicate a relatively high density of defects, such as cracks or inclusions in the material of the glass tube semi-finished product, the process parameters can be varied accordingly during further processing, in particular to the effect that defective sections of the glass tube semi-finished product are cut to length, sorted out and not further processed, so that according to the present invention only final products are manufactured without such defects. The same applies to all possibly relevant defects of an output glass tube.

In the context of the present invention, the defect data are basically understood to mean any characteristics of a glass tube semi-finished product which can have a negative influence on the quality of a final product and which can also be influenced by appropriate adjustment or adaptation of process parameters during the further processing of a glass tube semi-finished product, or which cannot be influenced by changing or adapting process parameters during the further processing of a glass tube semi-finished product, but which can only be influenced by sorting out or cutting off. The process parameters for the further processing of a glass tube semi-finished product are in particular the process conditions for the separation of sub-sections of a glass tube semi-finished product, such as the location and size of a separated area of the glass tube semi-finished product, or the process conditions for the further processing of a sub-section separated from the respective glass tube semi-finished product, such as the location of further processing at the separated area of the glass tube semi-finished product.

According to another preferred embodiment, the adaptation of the further processing of the glass tube semi-finished product does not include any control or regulation of a process parameter which concerns a thermal forming of the glass tube semi-finished product, i.e. in particular it does not include any control or regulation of a temperature, burner power, distance of the burner(s) to the glass tube semi-finished product for the thermal forming, orientation or alignment of the respective burner (s), process times of the thermal forming, process timing or synchronization of the thermal forming or the like, and in particular no control or regulation of process conditions during the further processing of a sub-section cut-off from the respective glass tube semi-finished product by thermal forming, such as temperature of the thermal forming, burner power, distance of the burner(s) to the glass tube semi-finished product during the thermal forming, orientation or alignment of the respective burner during thermal forming, process times of the thermal forming, process cycle of the thermal forming, process parameters during the thermal forming of the separated sub-section, such as application of an overpressure or underpressure, (section-wise) pressing of the separated sub-section into a mold or similar, thermal conditions during cooling, or the like.

In the simplest case, an adjustment of the further processing of the glass tube semi-finished product can be understood as an adjustment of process parameters according to a lookup table, in which process parameters assigned to the relevant characteristics of a glass tube semi-finished product or (separated) sub-section are stored, such as cutting parameters for cutting off sub-sections from the glass tube semi-finished product for further processing. Such a lookup table may be stored in particular in a database or on a data carrier, to which a control device of a further processing plant, for example a processor, has access. In the simplest case, the data of such a lookup table can be based on empirical data, but these may also be the result of calculations or numerical simulations or of corresponding test series, i.e. knowledge-based.

The further processing of the glass tube semi-finished product may, of course, also be adapted according to mathematical formulas or calculations into which the defect data provided are incorporated.

The “provision of the defect data” in the sense of the present invention means in particular that a further processing plant does not have to determine or measure again the relevant characteristics of a semi-finished glass tube to be processed, but rather that these data are made available to the further processing plant by the glass tube manufacturer in a suitable manner, either directly or indirectly, which helps to reduce the effort and costs involved in the further processing of glass tubes. For this purpose, appropriate access by the further processing plant to the data of the glass tube manufacturer may be provided, for example by providing access to a database operated by the manufacturer or by means of a data carrier provided by the manufacturer. In principle, the data may also be recorded directly on the glass tube, for example in a suitable marking, an adhesive label, an RFID tag or the like. In any case, the further processing company can simply read in the relevant defect data in a simple way, without having to measure or otherwise determine them again.

According to a further embodiment, the adaptation of the further processing of the glass tube semi-finished product includes the sorting out or temporary intermediate storage of a glass tube semi-finished product if, on the basis of the defect data for the glass tube semi-finished product, it is determined that the further processing of the glass tube semi-finished product is not possible with current process parameters or is only possible with insufficient quality.

According to a further embodiment, the defect data contain defect information for the entire length of the glass tube semi-finished product, in particular, the defect information contains information about all defects on the glass tube semi-finished product, including the type of defect as described below.

According to a further embodiment, the defect data are provided for sub-sections of the glass tube semi-finished product of a predetermined length in a longitudinal direction of the glass tube semi-finished product, which can be achieved in particular by continuous or segmental tub strand marking on the glass tube semi-finished product. The length of these subsections may be adapted in particular to the length of final products to be manufactured, including any waste or the like. In other words, for each end product to be produced, exact defect data are available for further processing of the glass tube semi-finished product during the further processing operation, on the basis of which the further processing of the respective glass tube semi-finished product can be adapted individually, including parameters for cutting to length and/or sorting out defective sections or sub-sections of the glass tube semi-finished product.

According to a further embodiment, the glass tube semi-finished product is further provided classified in one of several classes according to the averaged defect data. The advantage is that several semi-finished glass tube products of the same class can be processed with the same parameters, which makes further processing more effective, time-saving, cost-effective and reliable.

According to a further embodiment, the defect data include information on the quality of the glass tube semi-finished product, in particular at least one of the following information on defects in the glass tube semi-finished product: inclusions in a wall of the glass tube semi-finished product, including bubbles, nodes, crystalline regions and the like; mechanical damage to the surface or volume of the glass tube semi-finished product, including scratches, abrasion of material; inhomogeneities on the surface. In particular, a defect map may be provided for a particular glass tube semi-finished product to suitably adapt the further processing of the glass tube semi-finished product, or sub-sections thereof, including cutting to length and possibly sorting out defective sub-sections.

According to a further embodiment, the defect data further include information to the location and position and preferably also to the size of the defects of the glass tube semi-finished product, wherein this information is spatially resolved in the peripheral direction of the glass tube semi-finished product. The above-mentioned defect map for a particular glass tube semi-finished product is thus not only known in the longitudinal direction of the glass tube semi-finished product, but also in the circumferential direction, which enables the production of higher quality end products with more homogeneous characteristics even in the circumferential direction of the end product.

According to a further embodiment, the glass tube semi-finished product is marked with at least one marking on the basis of which the defect data for the glass tube semi-finished product can be read out (indirectly or indirectly). For example, the at least one marking may contain, in particular, a tube identification information which can be used to read out the defect data for the glass tube semi-finished product from a data memory or a database, in each case in association with a glass tube semi-finished product or a sub-section thereof, which is identified by the respective tube identification information. Defect data are thus provided indirectly, i.e. via the data memory, database or the like, and this approach can be easily and cost-effectively integrated into the processes of a further processing plant.

However, the defect data for the glass tube semi-finished product may also be included in other marks on the glass tube semi-finished product or in at least one further marking section of the at least one marking on the glass tube semi-finished product. The defect data can thus be made available immediately, i.e. by means of the information on the respective glass tube semi-finished product or on a respective sub-section thereof, which is written into the further marking or into the subsequent marking section.

According to a further embodiment, the at least one marking can be applied to the respective glass tube semi-finished product by means of one of the following methods: direct marking of a defect by mechanical notching, notching by laser treatment, baking of a pigment dye with a laser, ink-jet printing, laser marking; application, in particular printing, a bar code, bar marking or matrix code.

According to an alternative embodiment, the at least one marking may be generated by interaction of a laser beam with the glass of the glass tube semi-finished product. In principle, the laser marking can be produced at temperatures below the transformation temperature. This applies in particular to labels that no longer exist on the end product. In this case, laser marking does not have to meet the requirements placed on the end product, e.g. with regard to breaking strength.

According to a further embodiment, the at least one marking can be inscribed into a wall of the glass tube semi-finished product by interaction of a laser beam with the glass of the glass tube semi-finished product at temperatures above the transformation temperature of the glass, in particular as a digital matrix code (DMC). It is advantageous that this information can practically no longer be falsified at a later date and that such markings can be read out in a simple and cost-effective manner, especially visually and contact-free, which can be easily integrated into the processes normally carried out in a further processing plant.

According to a further embodiment, at least one glass tube semi-finished product is randomly measured and evaluated prior to further processing in order to carry out the process, particularly at the beginning of a further processing plant, for example during a goods receipt inspection. The quantities and evaluation data measured in this way are compared with the defect data provided for the respective glass tube semi-finished products in order to determine a deviation information, wherein the at least one process parameter used to adapt the further processing of a plurality of glass tube semi-finished products to the defect data read out for the respective glass tube semi-finished products, taking into account the determined deviation information. In particular, by random sampling measurements of glass tubes, any systematic deviations between the defect data provided by the manufacturer and the actual defect data can be reliably determined and subsequently corrected. In this way, for example, systematic measuring errors or similar errors on the part of a further processing plant can be reliably corrected and avoided in a simple way.

According to a further embodiment, further processing of the glass tube semi-finished product also includes a local heating of a portion of the glass tube semi-finished product and separation of a container by separating a portion from the glass tube semi-finished product in the region of the locally heated portion to form a base of the container. In particular, the base can be formed by collapsing and fusing of sufficiently plastic wall sections, which results in elongated end products or hollow glass products with at least one closed end. On the basis of the defect data, process parameters can be controlled or suitably set which influence the local heating of the portion of the glass tube semi-finished product and the separation of the container, in particular the power of burner(s) and an axial adjustment of holding sections of a further processing plant, which serve to hold (also temporarily) sections of the glass tube semi-finished product. However, in the context of the present invention the process parameters used for thermal forming are not controlled or regulated as a function of the defect data read out for the respective glass tube semi-finished product.

According to a further embodiment, when the container is separated from the glass tube semi-finished product, a neck or narrowed neck portion of the container is preformed, wherein the container is picked up upside down by a holding device and wherein the base of the container gradually forms from the glass tube semi-finished product by collapsing a wall of the glass tube.

According to a further embodiment, further processing of the base of the container is also provided for, with at least one of the following steps: working the base of the container with at least one burner to coarsely shape the base; further processing of the base with at least one burner to form the base flat; pressing the base into a molding matrix using a gas pressure, in particular in the range of 0.5 to 3.0 bar, to form the base to final shape; and cooling the base. The defect data can be used to control or set process parameters that affect one or more of these further process steps.

According to a further embodiment, further processing of the glass tube semi-finished product further comprises the sorting out or temporary intermediate storage of a glass tube semi-finished product if, based on the defect data for the glass tube semi-finished product, it is determined that further processing of the glass tube semi-finished product with current process parameters is not possible. In this way, in particular classes of glass tube semi-finished products with the same or comparable relevant characteristics can be formed, wherein entire classes of such glass tube semi-finished products (or sub-sections thereof separated and buffered from them) can be formed and these classes can then be further processed into the final product with identical or substantially identical process parameters. The advantage of this is that the relevant process parameters do not have to be varied so often, which provides further advantages for further processing. After temporary buffering, a new class can then be further processed, in particular with once changed or adapted process parameters, which are determined on the basis of the defect data for the glass tube semi-finished product.

According to a further embodiment, the final product after further processing is a container for pharmaceutical, medical or cosmetic substances, in particular a vial, a cartridge or a syringe body. More generally, the end product is a hollow glass product of the aforementioned type, which has at least one opening for filling in a substance.

### BRIEF DESCRIPTION OF THE DRAWINGS

The invention will be described in the following in an exemplary manner and with reference to the associated drawings, from which will ensue further features, advantages and objects to be achieved. The drawings show:

FIG. 1a a first embodiment of a glass tube semi-finished product according to the present invention with markings provided thereon which code defect data;

FIG. 1b a second embodiment of a glass tube semi-finished product according to the present invention with an enlarged representation of a marking provided thereon which codes defect data;

FIG. 1c a third embodiment of a glass tube semi-finished product according to the present invention with a marking provided thereon which indirectly codes defect data;

FIG. 2a in a schematic diagram, an apparatus for identifying a glass tube semi-finished product with tube-specific data and a plant for further processing a glass tube semi-finished product in order to implement a method according to the present invention;

FIG. 2b a database which stores defect data for a plurality of glass tube semi-finished products;

FIG. 3a a schematic flowchart of a first embodiment of a method for further processing a glass tube semi-finished product according to the present invention for producing an end product;

FIG. 3b a schematic flowchart of a second embodiment of a method for further processing a glass tube semi-finished product according to the present invention for producing an end product;

FIG. 4 three further embodiments of a method for further processing a glass tube semi-finished product according to the present invention for producing an end product; and

FIGS. 5a-5e further embodiments of a method for further processing a glass tube semi-finished product according to the present invention for producing an end product.

Identical reference numerals in the Figures indicate elements or groups of elements which are identical or have substantially the same effect.

### DETAILED DESCRIPTION OF THE INVENTION

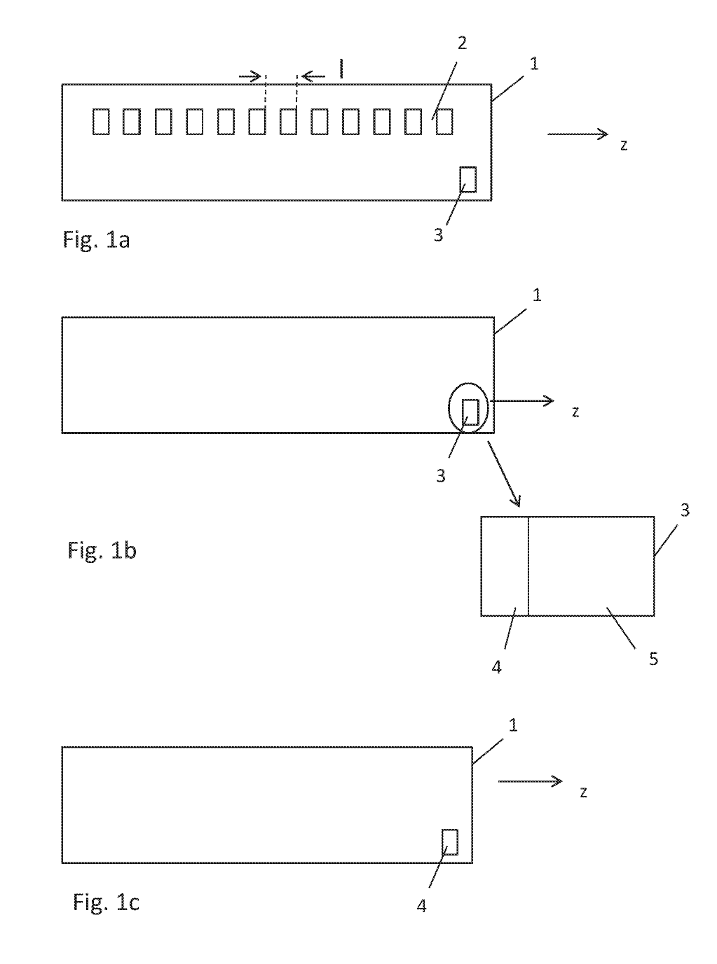

FIG. 1a shows a first embodiment of a glass tube semi-finished product according to the present invention with markings provided thereon. In the context of the present invention, a glass tube semi-finished product is to be understood in particular as a prefabricated glass tube with predetermined dimensions and characteristics which serves as an initial workpiece for further processing into end products made of glass, in particular into hollow glass products. Such glass tube semi-finished products are usually supplied in predetermined lengths of, for example, 1.5 m, one tube end or preferably both tube ends being sealed on delivery to a further processing company in order to prevent undesirable ingress of contaminants into the interior of the glass tube semi-finished product. For this purpose, the at least one end of the glass tube semi-finished product 1 may also be completely sealed by thermal forming.

During the production of the glass tube semi-finished product 1, a tube strand marking 2 is applied continuously to the glass tube 1 which marking in each case includes defect data for a particular subsection of a length 1 of the glass tube semi-finished product 1, as explained below. A second marking 3 is further provided separately from the tube strand marking 2 on the glass tube semi-finished product 1, said marking including tube identification information for identifying the glass tube semi-finished product 1, e.g., a tube ID, tube serial number or similar. Furthermore, the second marking may also indicate details about the manufacturer, place of production and/or production plant of the glass tube 1. The tube strand marking may basically remain unchanged up to the end product (for example pharmaceutical container). The information about the glass tube semi-finished product 1 are preferably not recorded in the markings 2, 3 in clear text without coding but rather can only be read out according to a predetermined calculation or decoding instruction.

According to FIG. 1a, the tube strand markings 2 are applied on the glass tube 1 in the longitudinal direction (z) of the glass tube, preferably at predetermined, constant distances (1) from each other. These distances 1 may be matched, for example, to the expected lengths of the section from which the end products (for example pharmaceutical containers) are later to be produced and which for this purpose have to be cut to length from an original glass tube semi-finished product, including any waste and sections to be cut off.

FIG. 1b shows a second embodiment of a glass tube semi-finished product according to the present invention with an enlarged representation of a marking provided thereon. According to FIG. 1b, instead of the first and second markings applied at spatially separate positions on the glass tube semi-finished product 1 at a predetermined location, for example at a front end or rear end of the glass tube semi-finished product 1, a combination marking 3 is provided which includes at least one first and one second item of information 4, 5 which are preferably arranged in close proximity to each other. While the first information 4 includes tube identification information, the second information 5 codes defect data for the particular glass tube semi-finished product 1 and also, if desired, for the individual subsections in the longitudinal direction of the glass tube semi-finished product 1 (cf. FIG. 1a), as explained below. Or the second information 5 codes a data link to these defect data so that these can be read out indirectly, e.g. from a database by using this data link.

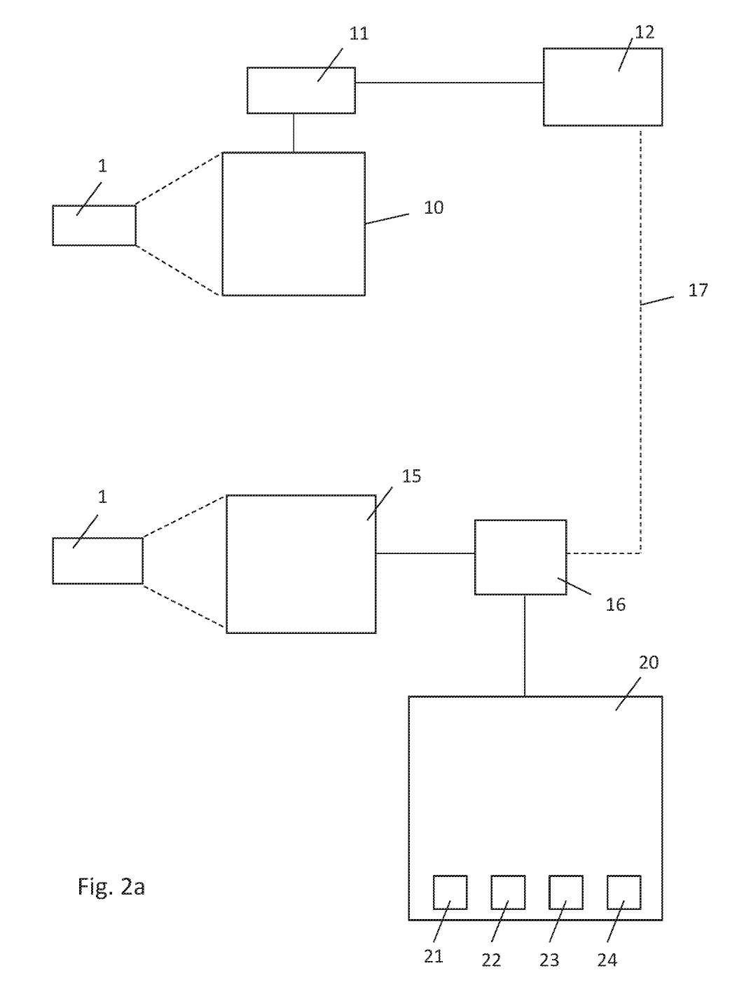

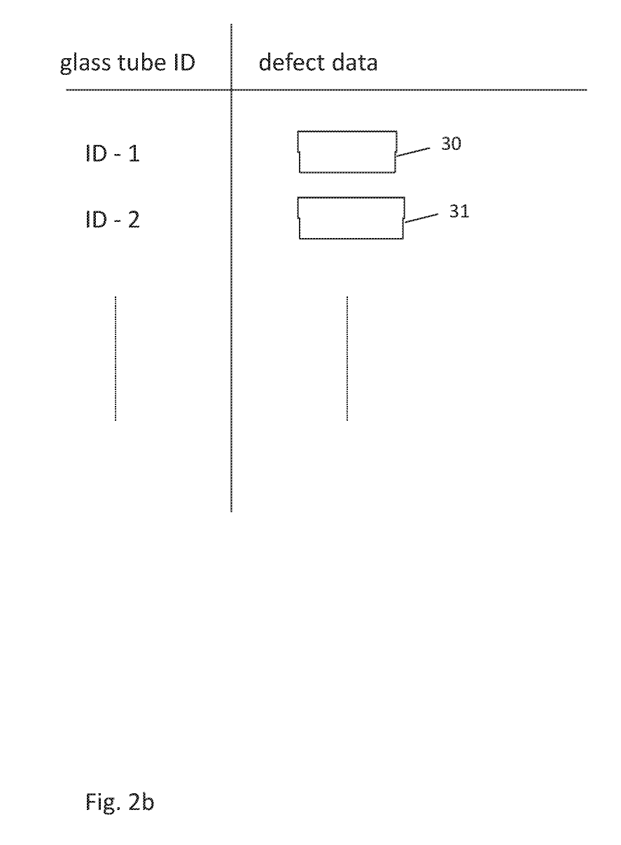

FIG. 1c shows a third embodiment of a glass tube semi-finished product according to the present invention with a marking provided thereon which indirectly codes defect data. For this purpose, the marking 4 codes tube identification information which uniquely identifies a glass tube semi-finished product 1, including all necessary details in order to carry out the method according to the invention, as explained below. For this purpose, it may be sufficient if the relevant defect data can be indirectly read out from a database based on tube identification information coded in the marking 4 or based on a data link coded by the marking 4, as described in greater detail below with reference to FIG. 2b.

In the above-mentioned examples, the defect information is marked indirectly on the glass tube semi-finished product, which can be accomplished particularly by one of the following processes:
applying a marking on the edge of the glass tube semi-finished product so that the further processing of the glass tube semi-finished product is not interfered, in particular by laser marking, baking of a pigment dye using a laser, ink jet printing;

According to further embodiments, the defect information may also be marked directly, in particular by one of the following procedures:
direct marking of the defect (a larger marking directly at defect position facilitates a detection) by: mechanical notching in the glass surface (scribing tool), notching by means of a laser treatment, baking of a pigment dye using a laser or ink jet printing;
coding (defect positions or tube numbers) at the end of the tube.

According to further embodiments, the defect information may also be marked by means of direct marking and additional coding at the end of the tube, i.e. by combining the two above-mentioned methods, in particular by direct marking with defect information modulated into the marking, for example by notching using a laser treatment, burning a pigment dye using a laser, ink jet printing or the like.

In the context of the present invention, the defect data may also relate to information on the quality of the glass tube semi-finished product, in particular at least one of the following items of information for the glass tube semi-finished product: inclusions in a wall of the glass tube semi-finished product, including bubbles, knots, crystalline regions and similar; mechanical damage to the surface or volume of the glass tube semi-finished product, including scratches, material abrasion; inhomogeneities on the surface or in the volume of the glass tube semi-finished product, including areas of a different optical refractive power and optical striae; defect type. The defect data also include information on the location and position and preferably also on the size of the defects in the glass tube semi-finished product.

For the purposes of this invention, these defect data are used to adapt a further processing of the glass tube semi-finished product to the defect data for the respective glass tube semi-finished product, as described in more detail below. This adaptation may include, in particular, the conditions and procedure for cutting off and/or sorting out defective glass tube semi-finished products or defective sections of a glass tube semi-finished product. The further processing of the glass tube semi-finished product may additionally include a thermal forming process carried out in sections, which is controlled or regulated by at least one process parameter. However, in the sense of the present invention this at least one process parameter that controls or regulates such a thermal forming process is not controlled or regulated by the defect data for the respective glass tube semi-finished product.

The method used for marking is also selected depending on the time of applying the markings 3-5. Thus, it may be sufficient if the markings 3-5 are applied at temperatures below a transformation temperature of the glass, for example by means of a laser marking, by imprinting a marking, for example a bar code or a line or matrix code marking, which codes the defect data or a data link to them. The defect data or a data link to them may also be coded in an adhesive label which is stuck onto the glass tube semi-finished product 1 in a suitable location and is removed again after reading out the relevant information before further processing of the glass tube semi-finished product 1. Or the defect data or a data link to them may be coded in a radio frequency identification (RFID) tag which is provided on the glass tube semi-finished product 1 at a suitable location and is removed again after contact-free reading out of the relevant information by means of radio frequency (rf) signals before further processing.

However, the markings 3-5 or parts thereof may also be produced at temperatures above the transformation temperature of the glass, preferably in the form of a digital matrix code (DMC) by means of a method as disclosed in US 2003 0029849 A1, DE 102 34 002 A1 and WO 2012 028611 A1 of the applicant, the content of which is expressly incorporated herewith by way of reference. The aforementioned data, in particular defect data, can be applied in this case in clear text (unencrypted) or using a predetermined coding.

While the tube strand marking 2 may basically remain unchanged up to the end product or hollow glass product (for example pharmaceutical container), the aforementioned further markings are removed again during further processing of the glass tube semi-finished product 1 into the end product at a further processing company, a new marking being applied if necessary at the further processing company according to a predetermined calculation or coding specification and while retaining the information content of the other markings, wherein said marking may be used for a further analysis.

FIG. 2a shows, in a schematic diagram, an apparatus for identifying a glass tube semi-finished product with defect data and a plant for further processing a glass tube semi-finished product in order to implement a method according to the present invention. Herein, the further processing of the glass tube semi-finished product may further include a thermal forming, which is performed at least in sections.

The upper part of the diagram in FIG. 2a illustrates an apparatus for applying a marking to the glass tube semi-finished product, including defect data, a tube identification information and other information. It is assumed in this case that the marking is applied to the glass tube semi-finished product using a digital matrix code (DMC) and by means of a method as disclosed in US 2003 0029849 A1, DE 102 34 002 A1 and WO 2012 028611 A1 of the applicant. Here, defect data, as explained above, are determined for the glass tube semi-finished product 1 by means of measuring device 10. In this case, the defect data may also be determined for a plurality of subsections which are arranged at a distance from each other along a longitudinal direction of the glass tube semi-finished product, preferably at constant distances from each other, as shown in FIG. 1a. After detection of the defect data, these are either stored in an external database 12 or these are recorded, for example on a data carrier, such as a data CD. This always takes place in association with information which permits a one-to-one identification of the particular glass tube semi-finished product, in particular of a serial number of the glass tube semi-finished product or a tube identification information (hereafter also referred to as tube ID). In this way, the defect data can be requested again indirectly and read out at a later time.

Alternatively or additionally, the defect data or at least substantial portions thereof, which are suitable for adaption of the subsequent further processing to the defect data of the glass tube semi-finished product 1, may also be applied using a marking device, which may also be part of the measuring device 10, directly to the particular glass tube semi-finished product 1, for example by means of markings, as described above with reference to FIGS. 1a-1c. In particular, the marking with the defect data may be applied to the glass tube semi-finished product using a digital matrix code (DMC) and by means of a method as disclosed in US 2003 0029849 A1, DE 102 34 002 A1 and WO 2012 028611 A1 of the applicant. However, the defect data may also be applied to the glass tube semi-finished product in a different way, in particular by means of a so-called RFID tag.

According to FIG. 2a, measurement or determination of the defect data and/or marking of the glass tube semi-finished product 1 takes place under the central control of a control device 11, which may also be connected to the database 12, in order to write data into it and/or read data out of it.

The lower part of the diagram in FIG. 2a shows schematically an apparatus 20 for further processing glass tube semi-finished products. This apparatus is typically operated by a further processing company which purchases the glass tube semi-finished products 1 and further processes them into end products, in particular hollow glass products, in particular into glass containers, for example into glass containers for storing substances for pharmaceutical, medicinal or even cosmetic purposes. The apparatus 20 is operated by a control device 16, in particular by a processor, which is connected to a reading device 15 in order to read at least one marking from the glass tube semi-finished product 1, as described above with reference to FIGS. 1a-1c, based on which the defect data for the particular glass tube semi-finished product 1 are read out indirectly, for example from a database 12 (via the network 17, for example an in-house computer network or the network, in particular via a secure data communication connection) or from a data carrier. The reading device 15, however, may also read the defect data for the particular glass tube semi-finished product 1 directly from the marking on the particular glass tube semi-finished product, for example by reading an optical marking on the particular glass tube semi-finished product 1 or by reading an RFID tag. The defect data are made available to the device 20 via a joint control device 16.

The apparatus 20 for further processing of glass tube semi-finished products may in particular be an apparatus for cutting off sub-sections of the glass tube semi-finished products, which are then processed into end products such as the aforementioned hollow glass products. The apparatus 20 for the further processing of glass tube semi-finished products may also be a device for sorting out and/or intermediate storage of glass tube semi-finished products of an insufficient quality, which are then either completely sorted out, i.e. not further processed into an end product, or which are then modified or adapted to the defects read out, after a processing of glass tube semi-finished products with sufficient quality has been carried out with the current parameters. It is conceivable, for example, that the location of the cutting to length or the location of subsequent further processing can be adapted and modified in accordance with the defect data read out for each glass tube semi-finished product or sub-section thereof.

For producing glass containers, the apparatus 20 for further processing of glass tube semi-finished products may in particular also include an apparatus known from EP 2 818 454 A1 of the applicant, which comprises a parent machine and a downstream base machine, with a plurality of processing stations for executing processing steps, which are generally referred to as subunits 21-24 in FIG. 2a, the specific number of which is expressly not intended to be limited to only the four subunits 24-24 shown. To produce glass containers, a glass tube is first attached to a holding unit of the parent machine, said glass tube then being brought, due to rotation of the parent machine, into the various processing positions in order to be preprocessed. Thereafter, the glass tube is separated in a separation process and the resulting glass containers are transferred to a holding unit of the downstream base machine in order to be further processed there at various processing positions. At the processing positions of the base machine, for example, various steps are taken to properly shape the base of a glass container. Here, in particular by means of various hot shaping processes and rapid rotation of the resulting glass containers, a flat container base is produced which has a relatively low viscosity during the process because of the prevailing high temperatures.

For the production of glass vials, for example, a plurality of burners are arranged at the various processing positions of the downstream so-called base machine. Both the downstream base machine and the upstream parent machine consist of a rotor portion and a stator portion, wherein the rotor portions rotate once around their own axis during a production cycle. The processing positions of the base machine are used for shaping the base of the glass vials separated from the glass tube and include at least one separating step involving the actual separation of the vials from the glass tube, a first base shaping step, a second base shaping step, a third base shaping step, a die base shaping step, a base cooling step, a removal step and an idle step. In all these processing steps, the glass vials are held upside down. Specifically, in the above-described processing steps, the following processing operations are cycled one after the other:

In the separating step, the resulting glass vials, the neck of which is already formed, are initially picked up upside down by a holding device of the base machine in order to then be separated from the glass tube, the base forming gradually on separation of the glass vial from the glass tube and on collapse of the wall of said glass tube. In the first base shaping step, the bases of the glass vials are processed with at least one burner in order to roughly shape the bases of the glass vials. In the second base shaping step, the bases of the glass vials are further processed with at least one burner in order to shape the bases of the glass vials flat. In the third base shaping step, the bases of the glass vials are further processed with at least one burner in order to further refine the already shaped bases of the glass vials. In the die base shaping step, the bases of the glass vials are pressed into a mold die using a relatively high gas pressure (preferably 0.5 to 3.0 bar) to finally shape the bases. In the base cooling step, the bases of the glass vials are finally cooled down. In the removal step, the finished glass vials are removed from the base machine. In the idle step, the holding unit of the base machine is empty, and it is prepared in order to pick up another new glass vial in the next step.

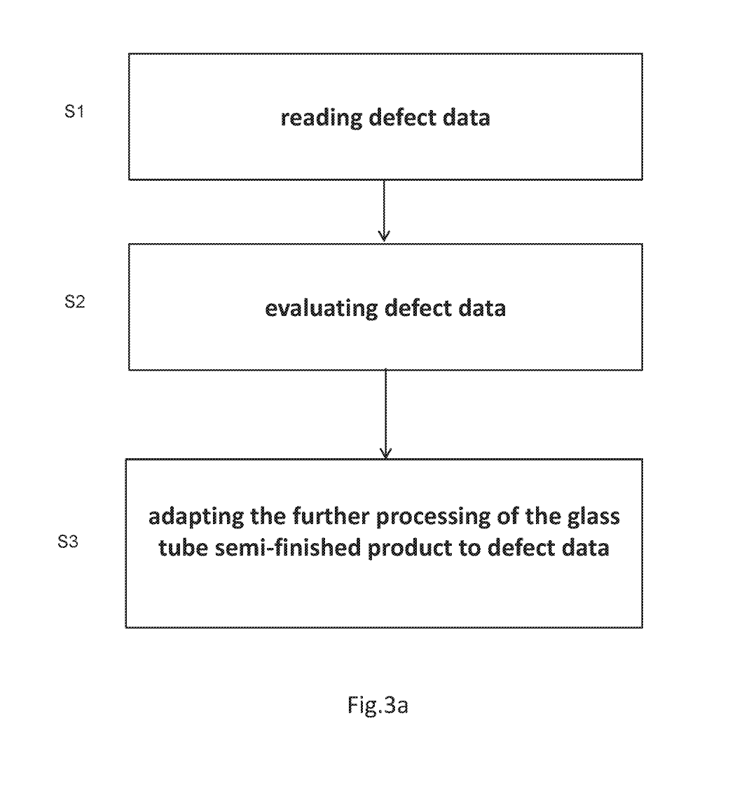

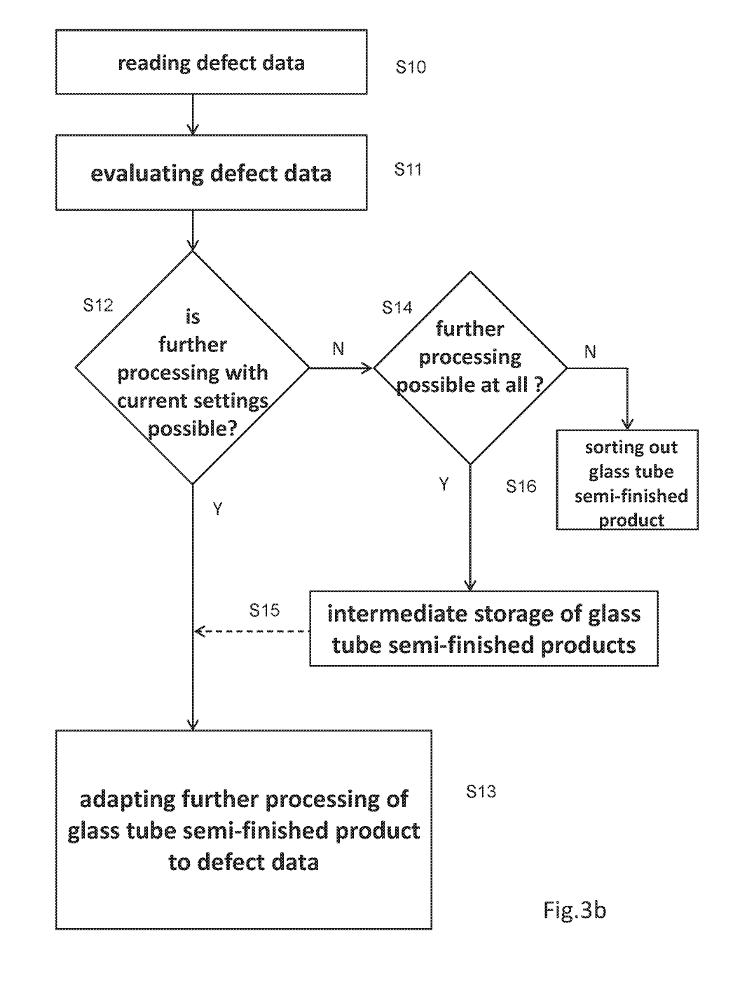

In the thermal deforming, the bases of the glass vials are relatively plastic during most of the processing steps, i.e. they have a relatively low viscosity. In this case, the process parameters during separation of the glass vials from a glass tube semi-finished product but also during the further processing steps for base shaping on the downstream base machine are appropriately selected and adjusted to the characteristics of each processed glass tube semi-finished product or each currently processed subsection of the respective glass tube semi-finished product—without using the afore-mentioned defect data, as described in greater detail below with reference to FIGS. 3a and 3b, with the aim of forming glass containers with highly homogeneous characteristics which always comply with the relatively tight tolerances required but which are also distinguished by further advantageous physical or physicochemical characteristics, in particular by a high chemical resistance, low ion emission, especially of alkali ions, in the substance to be stored in the glass container and a low delamination tendency. In this case, the so-called delamination is usually due to the fact that, due to the very high temperatures prevailing in the region of the glass container base, alkali borates, sodium and the like evaporate out of the hot glass which immediately re-deposit on cooler regions of the glass containers, in particular in an annular zone at a certain distance from the glass container base. This phenomenon, known as the delamination tendency, makes it difficult to ensure a constant, optimum quality of the glass containers. In the hot region, the stoichiometric composition of the glass in particular is changed. As a result of the subsequent cooling of the glass container, this results in a phase separation of the surface layer which may have a further adverse effect on the chemical resistance of the glass container. Due to the customary partially uncontrolled conditions during the hot forming processes, this leads to further irregularities in the manufacture of the glass containers.

For further processing of the respective glass tube semi-finished product by means of an additional step of thermal forming performed optionally, suitable process parameters are set at the plurality of subunits 21-24 of the device 20, for example process temperatures and/or process times and/or process cycles and/or process pressures and/or heating outputs of burners and/or rotational speeds for rotating the glass tube semi-finished product during further processing or similar. According to the invention, these process parameters are appropriately set during further processing of the glass tube semi-finished product, including the step of thermal forming carried out at least in sections, as a function of the defect data determined for the respective glass tube semi-finished product 1. However, according to the present invention these process parameters, which relate to the thermal forming, are not controlled or regulated by means of the control unit 16 as a function of the respective defect data. Rather, these process parameters are set appropriately on the basis of other criteria.

As shown in FIG. 2b, the defect data 30, 31 may be stored in the database, for example in the form of a lookup table in association with particular tube identification information tube ID 1, tube ID 2, etc.

Two embodiments of a method according to the present invention for further processing a glass tube semi-finished product into an end product, for example a glass container, are described below with reference to FIGS. 3a and 3b.

According to FIG. 3a, the defect data for a particular glass tube semi-finished product to be further processed are first read in step S1, for example by accessing an external database 12 (cf. FIG. 2a), by reading a data carrier or a marking which is provided on the glass tube semi-finished product. In step S2, the defect data read is then evaluated, in particular as to whether or not the process parameters currently set for the further processing apparatus will have to be changed for the glass tube semi-finished product currently to be processed. If it is determined in step S2 that the current process parameters of the further processing apparatus are also suitable for the newly processed glass tube semi-finished product or a subsection thereof, the further processing of the glass tube semi-finished product or the subsection thereof to be processed again is carried out with the current process parameters. Otherwise, the process parameters of the further processing are adapted to the defect data (step S3) of the glass tube semi-finished product or the subsection thereof to be processed again. After further processing of the glass tube semi-finished product or of the subsection thereof to be processed again, the method returns to step S1 in order to further process another glass tube semi-finished product or another subsection of the glass tube semi-finished product currently to be processed.

As an alternative to the method according to FIG. 3a, in the method according to FIG. 3b, after step S11 (corresponding to step S2 of FIG. 3a) it is first queried in step S12 whether further processing of the glass tube semi-finished product or of the next subsection thereof to be processed again is possible at all with the current settings of the process parameters of the further processing. If this is not the case, instead of immediately changing the process parameters, it is first checked in step S14 whether further processing of the glass tube semi-finished product to be processed again or of the next subsection of the glass tube semi-finished product currently to be processed is possible at all, i.e. if the process parameters were to be changed according to the respective defect data. If this is the case, the glass tube semi-finished product to be processed again or the next subsection of the glass tube semi-finished product currently to be processed is temporarily stored in step S15. Otherwise, the glass tube semi-finished product to be processed again or the next subsection to be processed of the glass tube semi-finished product currently to be processed is sorted out in step S16 because it has been determined in step S14 that further processing is not possible at all for the sorted glass tube semi-finished product or the next subsection to be processed.

Subsequently, the method first returns to step S10 and proceeds with a further processing of the next glass tube semi-finished product or of the next subsection of the glass tube semi-finished product currently to be processed (steps S10-S13), unless the next glass tube semi-finished product or the next subsection of the glass tube semi-finished product currently to be processed can also not be further processed (negative decision in step S14 and sorting out in step S16) or the next glass tube semi-finished product or the next subsection of the glass tube semi-finished product currently to be processed is also temporarily stored in step S15.

If a sufficiently large number of glass tube semi-finished products or subsections have been temporarily stored in step S15, after returning to step S10, the method may first suitably adapt or set the process parameters for the glass tube semi-finished products or subsections intermediately stored in step S15, and then further process these glass tube semi-finished products or subsections in step S13 using process parameters that correspond to the defect data for these glass tube semi-finished products or subsections. This results in a time saving because the process parameters for further processing do not have to be adapted permanently but only in groups, i.e. for the next group of glass tube semi-finished products or subsections which were temporarily stored in step S14.

In particular, step S14 is also suitable for pre-selecting glass tube semi-finished products or subsections into one or more classes of glass tube semi-finished products or subsections, for which the same process parameters have to be used for further processing so that the further processing may also be performed in groups or sequentially for such classes of glass tube semi-finished products or subsections, wherein the process parameters for further processing then only need to be adapted to the defect data for each new class of glass tube semi-finished products or subsections.

As a requirement for carrying out the method according to the invention, relevant defects of the glass tube semi-finished product must be detected or provided for further processing during tube production. This relates in particular to information on the quality of the respective glass tube semi-finished product during tube production, in particular at least one of the following items of information for the glass tube semi-finished product: composition of a glass melt which was used for tube shaping of the glass tube semi-finished product; inclusions in a wall of the glass tube semi-finished product, including bubbles, knots, crystalline regions and similar; mechanical damage to the surface or volume of the glass tube semi-finished product, including scratches, material abrasion; inhomogeneities on the surface or in the volume of the glass tube semi-finished product, including areas of a different optical refractive power and optical striae; defect type. The defect data also include information on the location and position and preferably also on the size of the defects in the glass tube semi-finished product

These defect data are no longer archived tube-specifically after a good/bad selection of the glass tubes, without a further processing company being able to access these data again later and it then having to repeat the corresponding measurements. Rather, according to the invention, the data arising during tube production with relevant information about the characteristics of a respective glass tube are made available to a further processing company so that individual further processing of the glass tubes can take place in accordance with these defect data and, according to the invention, a re-measurement of the relevant characteristics of the glass tube semi-finished product becomes superfluous. For this purpose, each tube in the manufacturing process receives a coding that contains measurement data either directly or indirectly as a data reference which can be read out to a further processing company and used for the further processing of the glass tubes.

A first application example concerns the use of defect measurement values to select glass tubes for the production of end products (e.g. hollow glass products) with narrow tolerances and/or a few defects of a predetermined maximum size, e.g. a glass tube with a nominal outer diameter of 10.85 mm and a tolerance of ±0.1 mm and defects with a maximum size of, for example, 0.1 mm in diameter. On the basis of the online measurement values, which were determined during glass tube production, the glass tubes are marked, e.g. with information on the size of the defects and the respective defect type (e.g. inclusion, scratches, air bubble, etc.). According to the present invention, the glass tubes are coded during production in such a way that the defect data measured during glass tube production are assigned to the glass tube. The assignment can be made either directly by writing the relevant measured values into a mark on the glass tube, or indirectly by coding each glass tube with a unique serial number and retrieving the relevant defect data for the glass tube from a list/database during further processing operations. The indirect method allows to provide considerably more defect data.

For the application example, the defects/defect types of glass tubes may be displayed in an upper, middle and lower tolerance range, for example. By reading out the measurement data, the glass tubes can then be selected in several classes and later individually treated with uniform parameters, which are adapted to the defects/defect types, according to the respective class. The simplest application, for example, is the pre-sorting of the glass tubes into defect type classes and further processing in groups according to these defect type classes, each with process parameters that are adapted to the respective defect type class. The advantage is the considerably more stable processing of the glass tube with standardized settings of the processing equipment and minimal user intervention. In this way, it is possible to produce closely tolerated end products and/or end products of higher quality without requiring the output glass tube to comply with maximum defect limits, which would entail extreme expenditure and high downtime for the manufacturer. Compared to the current state of the art, there is no longer any need to measure the tubes over their entire length. The data can, for example, be read directly from a simple code reader on the tube.

Another possible application is the use of defect data for adapting the operation of tube processing machines, such as cutting devices.

Likewise, individual tubes with undesirable characteristics could be sorted out, e.g. tubes with too large defects.

Advantages for the tube manufacturer are reduction of the product range since few tolerances suffice to serve a wide variety of requirements in further processing.

Application example of incoming goods inspection (at the further processing company):

Instead of inspecting samples of delivered glass tubes for compliance with tolerances, statistical parameters, etc. during the incoming goods inspection at a further processing plant, according to the present invention a comparison of the measurement data from the manufacturer and the further processing plant (=user) may be made on the basis of the defect data, i.e. on the basis of specific measurement data of glass tubes, at the further processing plant. This adjustment only needs to be carried out for a few delivered glass tubes, as the deviations for all other glass tubes can then be calculated accordingly. This dramatically reduces the effort required for incoming goods inspection during processing operations and significantly increases the accuracy of comparison measurements. Unlike machine-made parts, glass tubes have defects in the material or on the surface due to the manufacturing process, such as mechanical damage to the surface or the volume of the glass tube semi-finished product, including scratches, material abrasion, inhomogeneities on the surface or in the volume of the glass tube semi-finished product, including areas of other optical refractive power and optical striae. Usually, direct comparative measurements with high accuracy are not possible due to error fluctuations, since small deviations of the measuring positions (some mm) can lead to measurement errors of several p.m. In order to avoid this effect, the defect position, defect size and defect type can be stored in the code of the glass tube in order to enable exact comparative measurements. This procedure thus enables the transition from random inspections to single-piece inspections as a basis for virtually zero-defect production.

The data on the glass quality of the glass tube itself (e.g. bubbles, knots, crystals, etc.) can thus be stored in the code and the conditions for individual processing of the glass tubes can be adapted to the glass quality of the glass tube (or, more generally, to the respective defect data).

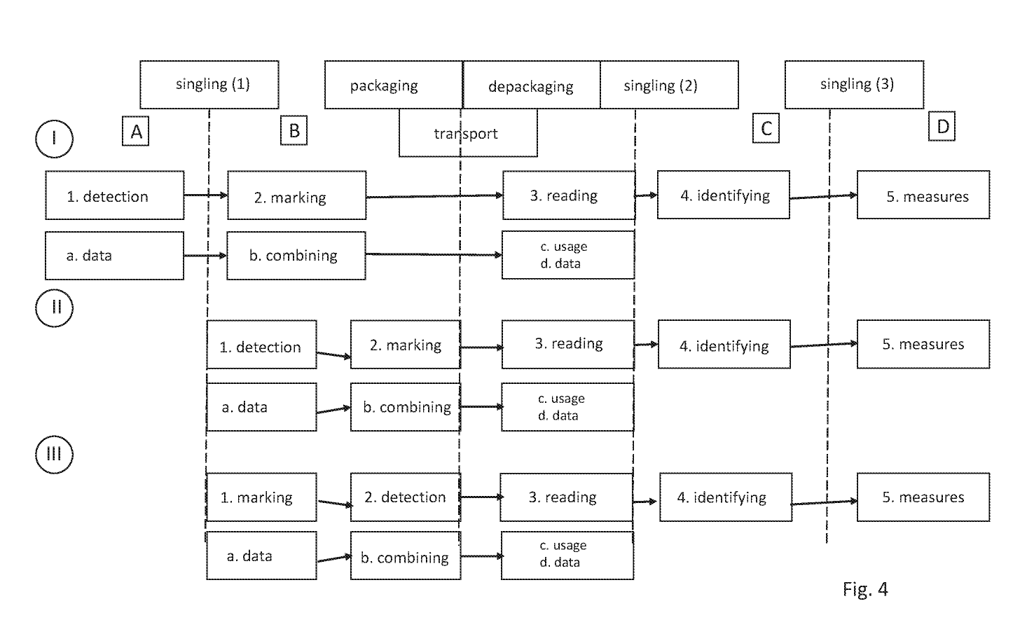

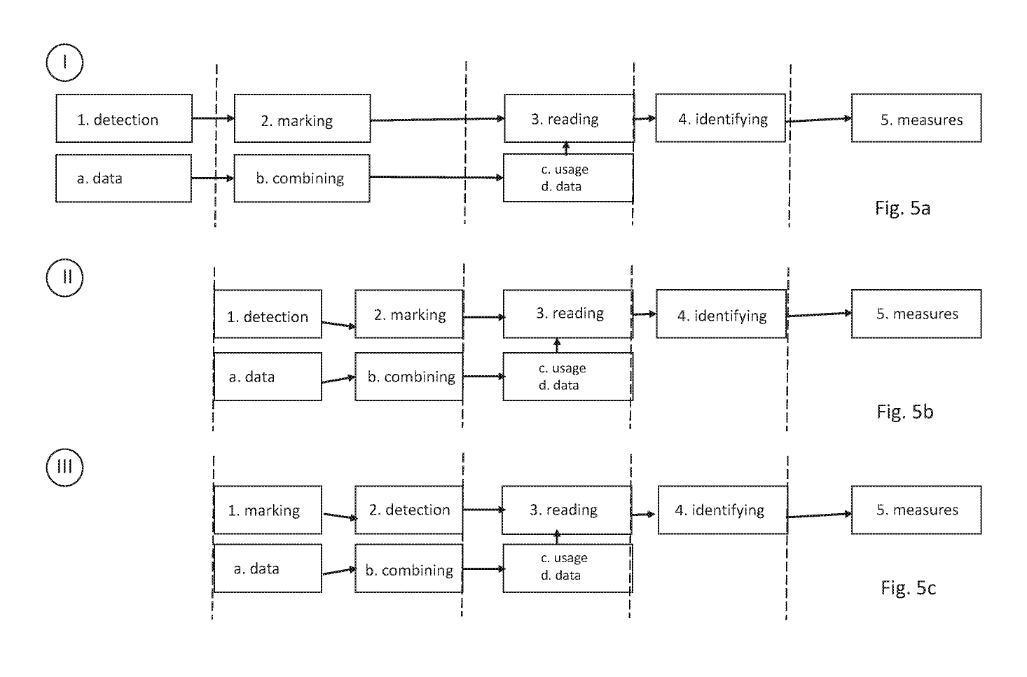

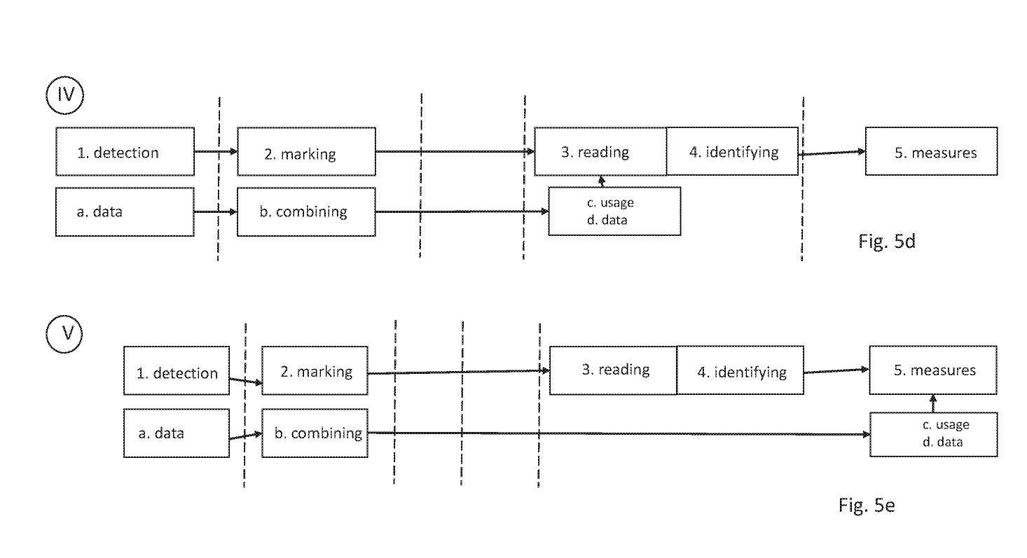

As explained above, the aforementioned marking is not a traceability mark, in particular not for tracing back to hot forming, as the recorded defect data are not used to find defects in the predecessor processes for the manufacture of the glass tube semi-finished product or to identify the responsibility for defects. Rather, the defect data is used to adapt the conditions during further processing (as shown in the following process flow diagrams according to FIGS. 4 and 5a-5e) to the respective defect data, which in extreme cases can lead to the rejection of the end product.

Referring to FIGS. 4 and 5a-5e, further preferred embodiments of the process according to the present invention will be described in the following.

More specifically, FIG. 4 shows in three process flow diagrams, one above the other, three variants (I to III) of a process according to the present invention.

As shown in the upper part of FIG. 4, the quality of the tubing is checked during the hot forming process of the glass tube strand from which the glass tube semi-finished products are separated (step 1). In particular, defect data for the glass tube strand are determined here. The defects can be measured individually, especially with regard to size and position, and preferably also a type of defect (inclusion, scratches, air bubble, etc.) is determined. The corresponding defect data shall be used to adapt the further processing of glass tube semi-finished products, in particular to separate sub-sections of a glass tube semi-finished product, to sort out glass tube semi-finished products or sub-sections thereof from a glass tube semi-finished product, or for further processing at another location carried out on the respective glass tube semi-finished product, in particular a location with suitable defect data indicating sufficient quality at that location. In the long term, the error data is stored in a database or on a data memory with access to it by a further processing company (step 1a).

If, after the glass tube semi-finished products have been separated, an individual number is applied to each glass tube semi-finished product (step 2), i.e. a consecutive serial number, and this number is linked to the defect data stored in the database or on the data carrier for the tube quality in general (step 2b) and to a quality map of the glass tube semi-finished product (i.e. at which location on the glass tube semi-finished product which defect or quality defect exists), it is now possible, after packaging the glass tube semi-finished product again, to read this individual number for the further processing of the glass tube semi-finished product (step 3) and to look up the quality or defect of the respective glass tube semi-finished product in the database or on the data carrier (step 3c). If the overall quality and the quality map are known, it is now possible to calculate (or determine) the defect data for the individual tube section (step 4) and to adapt the further processing to the defect data of the tube section (step 5) after (or before) the separation of sub-sections of the glass tube semi-finished product, from which hollow glass products such as vials, cartridges or syringe bodies are produced by thermal forming and to the subsequent processing of the defect data (step 5), or, in extreme cases, the tube section is rejected due to insufficient quality.

The defect data contains information on the cosmetic and dimensional characteristics of the glass tube semi-finished product, especially on production defects and their coordinates (quality map of the glass tube semi-finished product). Linking the defect data to the glass tube semi-finished product means in particular a direct linking, in particular by applying an individual number or a code (serial number, bar code or QR code) by direct writing on the glass tube semi-finished product with a laser, by printing or applying labels or arranging the glass tube semi-finished product in a defined sequence in a stack of glass tube semi-finished products and placing it underneath, and by recording the defect data also in relation to the sequence of the glass tube semi-finished products in this stack of glass tubes. The use of the defect data includes, in particular, making available (digitally as well as analogously) a quality map of the individual glass tube semi-finished product, e.g., via digital means making available the digital defect data on a server, a database or another storage medium by coding of the glass tube semi-finished product, or via analogous means by passing on the quality map of the glass tube semi-finished product or by applying individual or several defect images directly to the glass tube semi-finished product (e.g. by laser coding of so-called airlines).

Further explanation of terms used:

Detection is in particular the inspection of the semi-finished glass tube produced for cosmetic and dimensional quality by means of control devices, in particular control devices for visual inspection. In this context, marking includes in particular all individual markings of the glass tube such as individual numbers, QR codes, bar codes, line scan codes that are applied to the glass tube semi-finished product, for example by means of lasers, labels or colors. Marking also involves indirect individualization of the glass tube semi-finished products, for example by placing the glass tube semi-finished products in a known sequence in a stack and individualizing the stack or placing the glass tube semi-finished products in a sequence on a pallet and individualizing the pallet. Selecting also includes methods of non-individual selection, such as marking of the glass tube semi-finished products with lower quality by means of a number, QR code etc. or direct marking of the defect by means of a symbol, in particular marking of the region of lower quality by applying a marking by laser, color and labels, e.g. laser marking of defects e.g. airlines.

In this context, reading the markings includes in particular methods of reading numbers, barcodes and QR-codes etc., but also the reading in by means of imaging the above listed non-individual codes by object recognition imaging methods. The marking may be read in explicitly before separating (step 2) the glass tube semi-finished products in the stack, but also after separating (step 2) the glass tube semi-finished products from the stack or, in case of direct marking of the regions of poor quality, also after separating (step 3) in the tube section or in the end product.

Identification of the region of inferior quality can take place e.g. directly by recognizing the defect marking code, preferably indirectly by reading in or calculating the individual number, mapping the regions of inferior quality, calculating the tube section where measures are necessary and the like.

Measures in this context include, in particular, adjustments to the process resulting from the region of inferior quality and from the lack of quality, in particular
sorting out of tube sections, semi-finished products and products due to critical quality defects which cannot be compensated for, in particular from so-called stones, airlines, cracks before hot forming after separation (step 3), after hot forming or passing these defect data to the end customer;
furthermore, in particular further processing at a suitable location of a respective glass tube semi-finished product for which the defect data indicate sufficient quality, wherein this further processing may also include further processing including a thermal forming carried out at least in sections, as described above.

Further explanations to the examples according to FIGS. 5a to 5e:

The process variant II according to FIG. 5b is analogous to method variant I according to FIG. 5a (which corresponds to process variant I shown in FIG. 4), except that the detection in variant II is carried out after separation (1).

The process variant III according to FIG. 5c is analogous to method variant II according to FIG. 5b, except that the detection in variant III is carried out according to that of the marking.

The process variant IV according to FIG. 5d is analogous to process variant I-III according to FIGS. 5a to 5c, whereby the first process steps are carried out analogously to process variant I, II or III. In this case, however, the error data are only read and used after separation (3).

Process variant V is analogous to process variant I-III, wherein the first process steps are performed in the same way as for process variant I, II or III. In this case, however, the error data is only used after production and separation (step 5). The error data may, for example, indicate to the further processing company whether the airline that is currently being detected is open or closed.

Another process variant VI (not shown) is a combination of the above-mentioned variants I-IV.

In particular, the following positions in the tube manufacturing process are conceivable for defect detection and marking of the surface of the glass tube semi-finished product:

| position of defect detection in tube | position of marking of the glass |
|---|---|
| production process | surface in tube production process |
| in finishing line (on individual | in finishing line (on individual |
| tube) | tube) |
| in the drawing line on the tube | in the drawing line on the tube |
| strand | strand |
| | in finishing line (on individual |
| | tube) |

The method according to the present invention is generally suitable for the further processing of glass tubes for the production of any closely toleranced end products. A preferred example of such end products are containers for substances for pharmaceutical, medicinal or even cosmetic applications, for example vials, cartridges or syringe bodies.

### LIST OF REFERENCE NUMBERS

1 Glass tube or glass tube semi-finished product

2 Tube strand marking

3 Tube marking

4 Tube identification information

5 Additional tube data

10 Measuring device/measuring and marking device

11 Control device (on the site of glass tube manufacturer)

12 Database

15 Readout device

16 Control device (at downstream further processing company)

17 Network

20 apparatus for further processing

21 subunit 1 of apparatus for further processing 20

22 subunit 2 of apparatus for further processing 20

23 subunit 3 of apparatus for further processing 20

24 subunit 4 of apparatus for further processing 20

30 defect data for tube-ID1

31 defect data for tube-ID2

1 Predetermined distance

Z Longitudinal direction

What is claimed is:

1. A method for further processing a glass tube semi-finished product, comprising the steps of:
providing the glass tube semi-finished product, wherein defect data are provided for the glass tube semi-finished product;
reading out the defect data for the glass tube semi-finished product; and
further processing the glass tube semi-finished product, the further processing including a thermal forming carried out at least in sections, wherein at least a part of the further processing of the glass tube semi-finished product is adapted to the defect data read out for the glass tube semi-finished product.

2. The method according to claim 1, wherein the step of adapting the further processing of the glass tube semi-finished product does not comprise controlling or regulating a process parameter which concerns a thermal forming of the glass tube semi-finished product carried out at least in sections.

3. The method according to claim 1, wherein the step of adapting the further processing of the glass tube semi-finished product comprises one of sorting out or temporarily storing a glass tube semi-finished product if, on the basis of the defect data for the glass tube semi-finished product, it is determined that further processing of the glass tube semi-finished product is one of (i) not possible with current process parameters or (ii) only possible with an insufficient quality.

4. The method according to claim 1, wherein the defect data include defect information for the entire length of the glass tube semi-finished product.

5. The method according to claim 1, wherein the defect data are provided in each case for sub-sections of the glass tube semi-finished product of a predetermined length in a longitudinal direction of the glass tube semi-finished product.

6. The method according to claim 1, wherein the glass tube semi-finished product is provided classified into one of several classes according to the averaged defect data.

7. The method according to claim 1, wherein:
the defect data include at least one of the following information on defects in the glass tube semi-finished product:
inclusions in a wall of the glass tube semi-finished product;
mechanical damage to the surface or volume of the glass tube semi-finished product;
inhomogeneities on the surface or volume of the glass tube semi-finished product; and
defect type; and
the defect data further include information regarding at least one of the location, the position and the size of the defects of the glass tube semi-finished product.

8. The method according to claim 7, wherein the inclusions include at least one of bubbles, nodes, and crystalline regions.

9. The method according to claim 7, wherein the mechanical damage includes at least one of scratches and material abrasion.

10. The method according to claim 7, wherein the inhomogeneities include at least one of areas of different optical refractive power and different optical striae.

11. The method according to claim 1, wherein the defect data include information regarding at least one of the location, the position and the size of the defects of the glass tube semi-finished product, said information being spatially resolved in the circumferential direction of the glass tube semi-finished product.

12. The method according to claim 1, wherein the glass tube semi-finished product is marked with at least one marking, and wherein the defect data for the glass tube semi-finished product are read out on the basis of the at least one marking.

13. The method according to claim 12, wherein the at least one marking includes a tube identification information, and wherein the defect data for the glass tube semi-finished product are read from a data memory or a database on the basis of the tube identification information.

14. The method according to claim 12, wherein the defect data for the glass tube semi-finished product are included one of (i) in further markings on the glass tube semi-finished product or (ii) in at least one further marking section of the at least one marking on the glass tube semi-finished product.

15. The method according to claim 15, wherein the at least one marking is applied by one of the following methods:
direct marking of a defect by one of mechanical notching, notching by laser treatment, baking of a pigment dye with a laser, ink-jet printing, or laser marking;
application by one of printing, bar marking or matrix code marking, which encodes one of the defect data or a data link to the defect data;
attachment of an adhesive label containing one of the defect data or a data link to the defect data; and
attachment of an RFID-tag to the glass tube semi-finished product, the RFID-tag containing coding of one of the defect data or a data link to the defect data.

16. The method according to claim 12, wherein the at least one marking is generated by interaction of a laser beam with the glass of the glass tube semi-finished product.

17. The method according to claim 16, wherein the at least one marking is generated in a wall of the glass tube semi-finished product by interaction of a laser beam with the glass of the glass tube semi-finished product at a temperature above the transformation temperature of the glass, as a digital matrix code (DMC).

18. The method according to claim 15, wherein the at least one marking is read out optically and contact-free in order to read out the defect data for the glass tube semi-finished product.

19. The method according to claim 1, wherein:
at least one glass tube semi-finished product is measured and evaluated prior to further processing;
measured quantities and evaluation data are compared with the defect data for the at least one glass tube semi-finished product to determine a deviation information; and
the further processing of a plurality of glass tube semi-finished products is adapted to the defect data which are read out for the respective glass tube semi-finished products, taking into account the determined deviation information.

20. The method according to claim 1, wherein the further processing of the glass tube semi-finished product comprises local heating of a portion of the glass tube semi-finished product and separating a container from the glass tube semi-finished product in the region of the locally heated portion to form a base of the container.

21. The method according to claim 20, wherein:
a neck of the container is preformed during the separation of the container from the glass tube semi-finished product,
the container is received upside down by a holding device, and
the base of the container is formed gradually from the glass tube semi-finished product by collapsing a wall of the glass tube.

22. The method according to claim 21, further comprising:
further processing the base of the container by at least one of the following steps:
processing the base of the container with at least one burner in order to roughly shape the base;
further processing the base with at least one burner in order to shape the base flat;
pressing the base into a mold die by applying a gas pressure in the range between 0.5 to 3.0 bar in order to finally shape the base; and
cooling of the base.

23. The method according to claim 22, wherein the glass tube semi-finished product is further processed after temporary storing, with modified process parameters determined on the basis of the defect data for the glass tube semi-finished product.

24. The method according to claim 20, wherein the container is a container for storing one of pharmaceutical, medical or cosmetic substances, the container being configured as one of a vial, a cartridge or a syringe body.
